(19) United States
(12) Patent Application Publication
(10) Pub. No.: US 2010/0180554 A1
(43) Pub. Date: Jul. 22, 2010

(54) PACKAGING PLANT COMPRISING AT LEAST TWO COMBINED VERTICAL FORMING TUBES

(76) Inventor: Gino Rapparini, Bologna (IT)

Correspondence Address: PAUL A. FATTIBENE;FATTIBENE & FATTIBENE, 2480 POST ROAD, SOUTHPORT, CT, 06890, US

(21) Appl. No.: 12/452,312

(22) PCT Filed: Jul. 13, 2007
(86) PCT No.: PCT/IB2007/001974

§ 371 Date: Mar. 17, 2010

(51) Int. Cl. B65B 9/20; B65B 61/28; B65G 17/32

(52) U.S. Cl. 53/545; 53/202; 198/836.1

(57) ABSTRACT

Packaging plant comprising at least two combined vertical forming tubes, comprising a single motorized central conveyer equipped with dragging devices D, D′ constituting at least two separate parallel tracks whose intermittent advancement is actuated by its main central motor C.

### FIELD THE ART

The present invention refers to the packaging plants with machines having a vertical forming tube. The international classification of reference is B65 b and B65 d.

### STATE OF THE ART

It is known the circumstance that in order to increase the hourly production of packaging machines with vertical forming tube, the operational speed of all the single actuating devices of the packaging process needs to be increased. Said increase in operational speed necessarily implies the occurrences of accelerations that alter the evolution of the various phases of the technological process and the reliability of the different operations that necessarily need to be realized in shorter times.

The problem to be solved is that of increasing the hourly production without increasing the operational speed of the single actuating devices that realized the different phases of the packaging process. The solution proposed by the present invention doubles the hourly production of the plant leaving unaltered the operational speed of the single devices that realized the different phases of the packaging process.

### DESCRIPTION

The invention is now disclosed with reference to the figures of the drawings attached as an unbinding example.

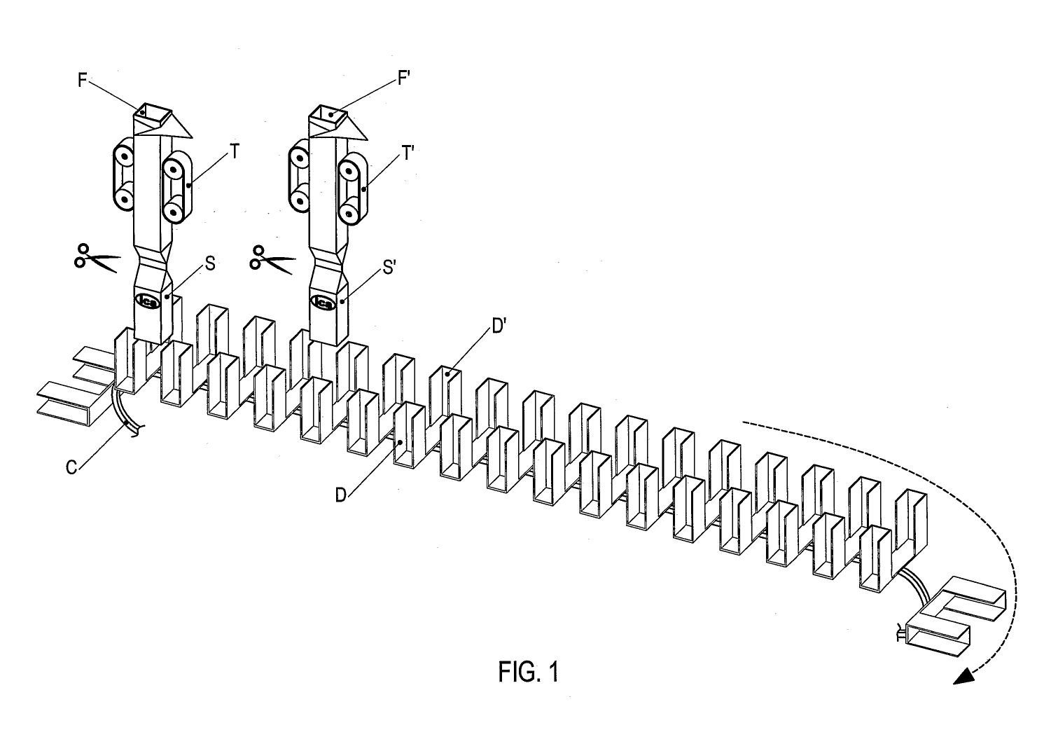

FIG. 1 schematized a packaging plant comprising a single central motorized conveyor C set up along two parallel rows of dragging devices D, D′. It should be pointed out the fact that the dragging devices DD, D′ are fed by the two vertical forming tubes F, F′ that are especially separated and placed by the under-transiting parallel rows of dragging devices D, D′. Furthermore, still in FIG. 1, it should be noticed that the two vertical forming tubes F, F′ are especially distanced from each other for reasons of room occupation. It should be pointed out that in FIG. 1 the two vertical forming tubes are represented in their initial phase when the two bags S, S′ are already packaged but not yet cut off.

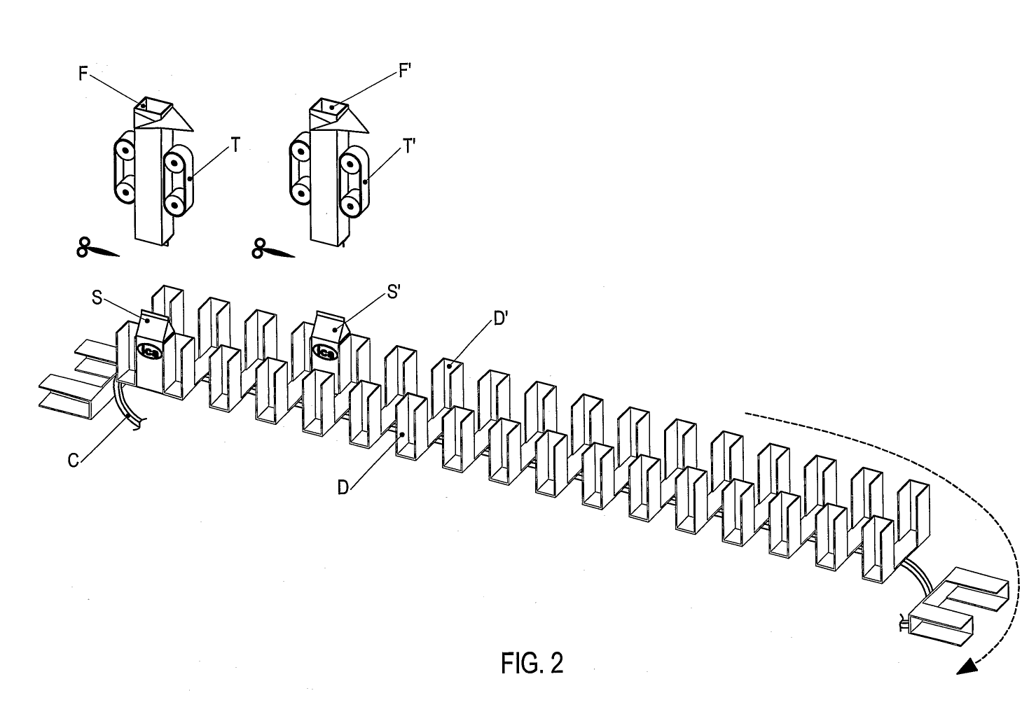

FIG. 2 represents the following phase, when the first two packaged bags S, S′ have already fallen amongst the dragging devices D, D′ that set up in parallel rows the single central conveyor C. It should be noticed, still in FIG. 2, that the bag S′ has fallen a few steps ahead of the bag S along the single conveyor C, for reasons of overall dimensions.

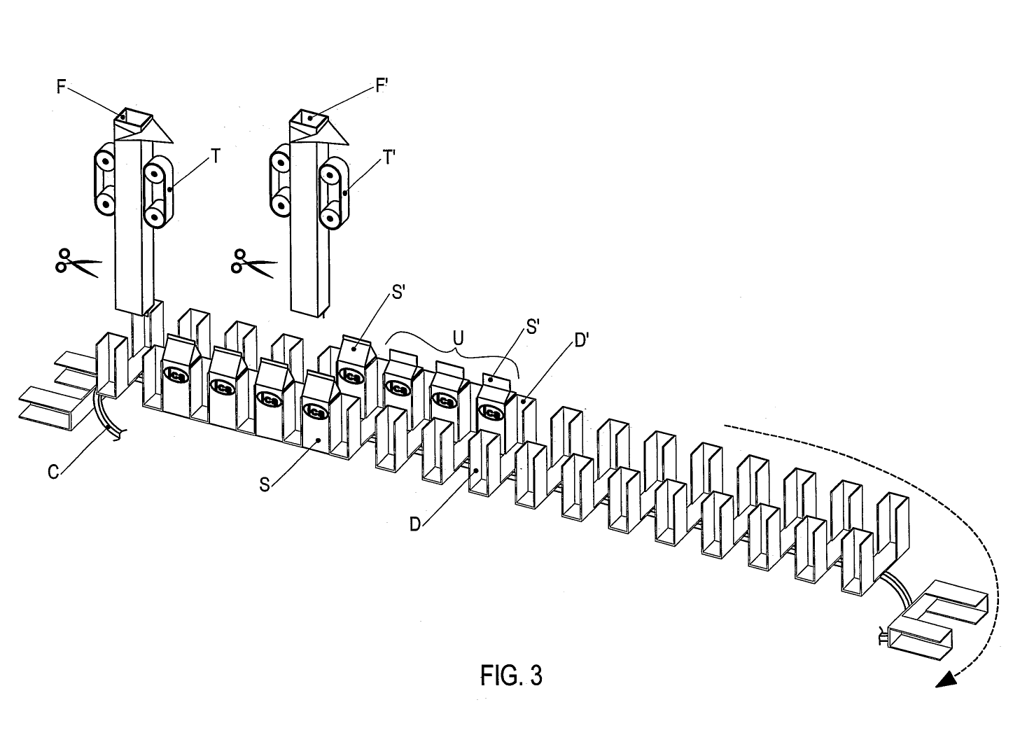

FIG. 3 represents the evolution of the feeding phases of the following bags S, S′. It should be noticed that some bags have already been placed in both the parallel tracks between the dragging devices D, D′, set-up on the single central motorized transporting conveyor C.

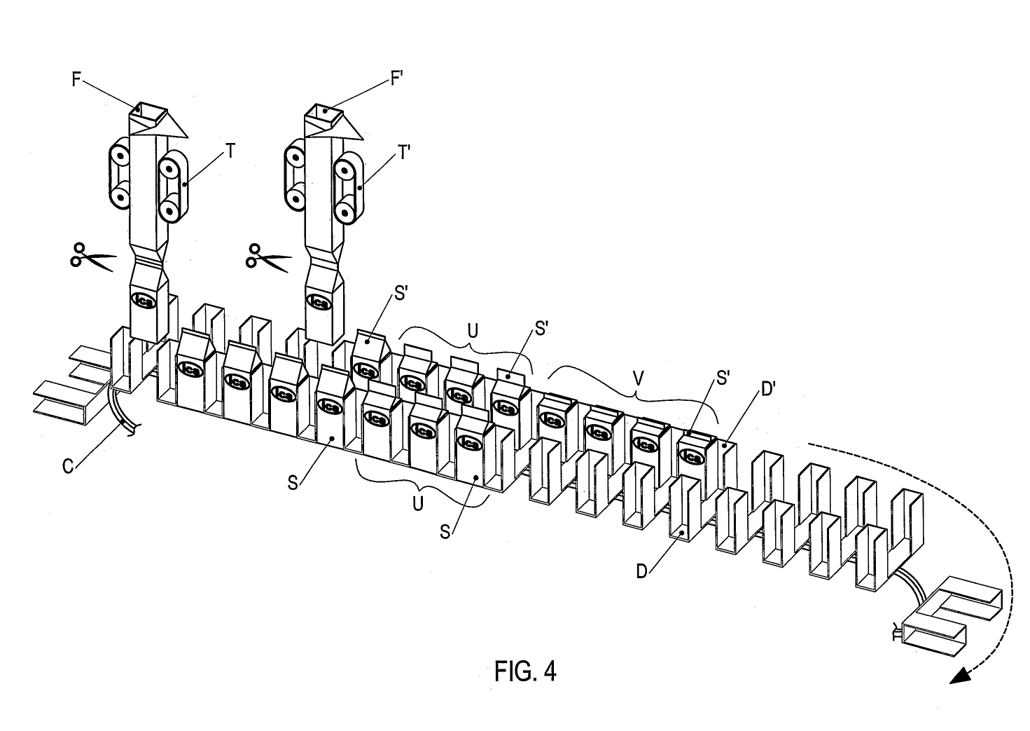

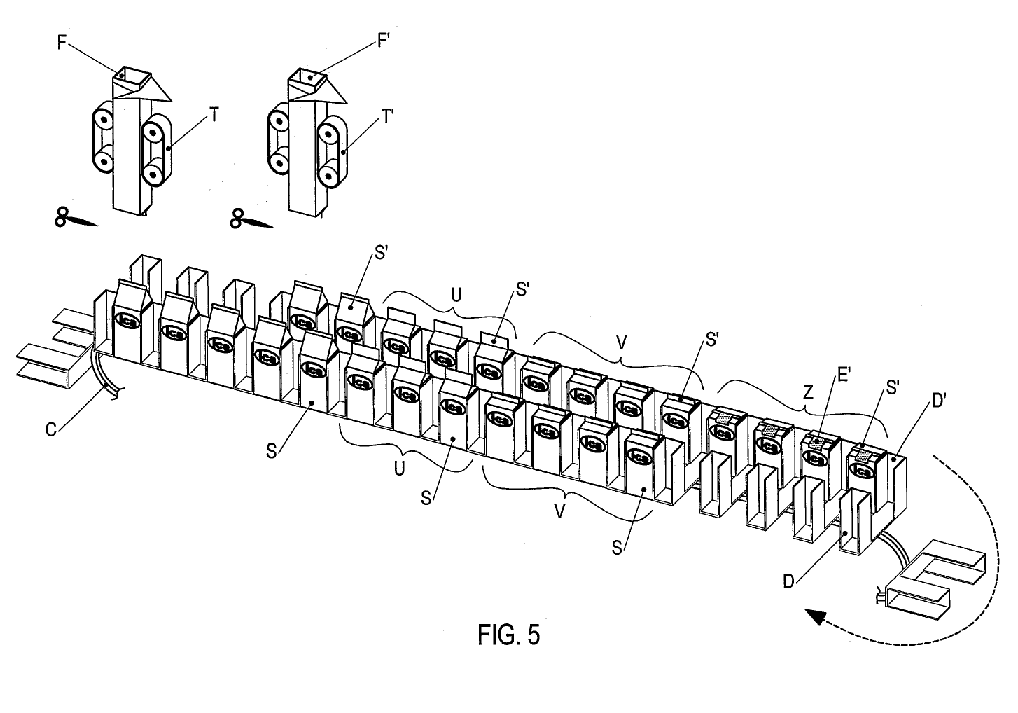

FIGS. 4 and 5 shows the unfolding of some likely operations of treatment of the head of the bags.

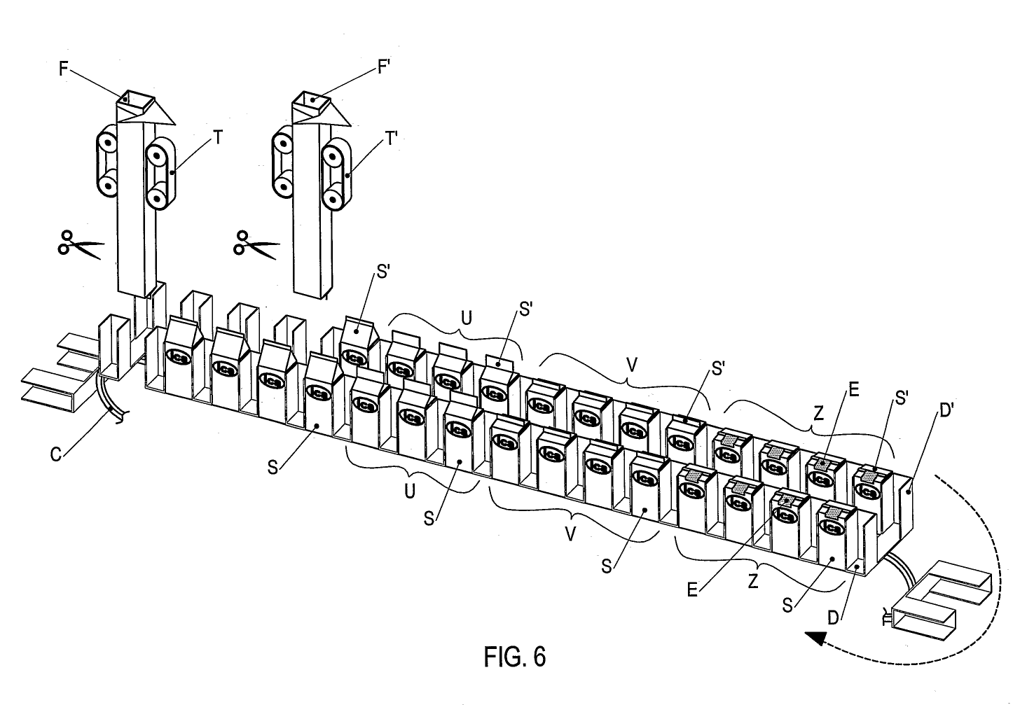

FIG. 6 shows the position of the plant with both the tracks in simultaneous production.

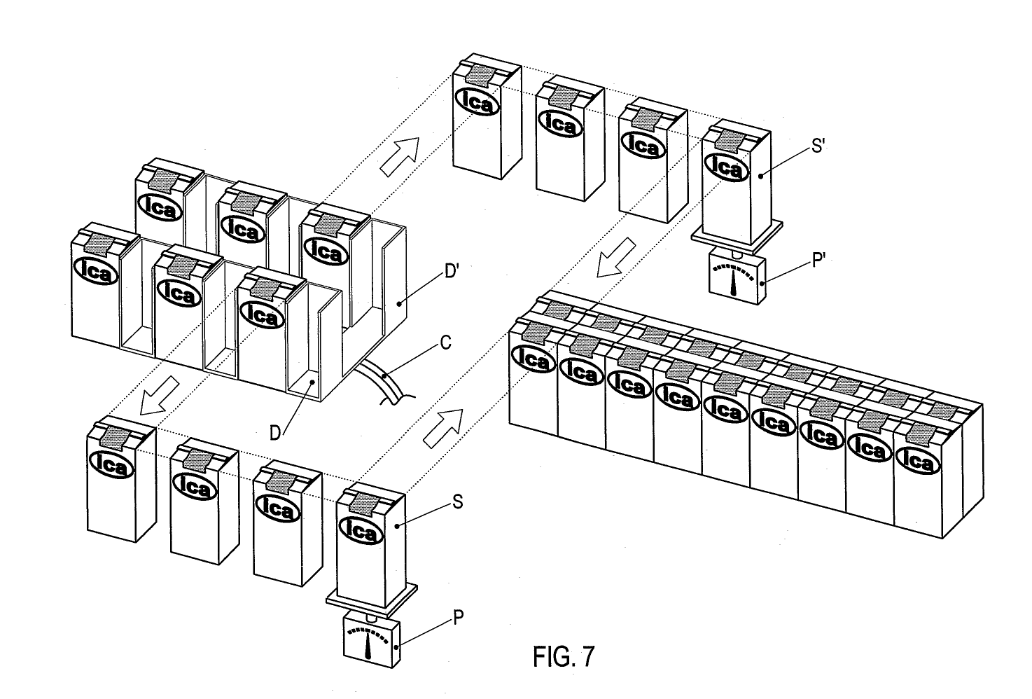

FIG. 7 shows the phase of side removal of the parallel rows of bags S, S′ and their possible coming near after the weight control operations P, P′.

In all figures each single detail is marked as follows:

C is a single central motorized and intermitting horizontal conveyor.

D and D′ are dragging devices of the packaged bags.

E indicates the labels applied on the folded fin of the bag.

F, F′ are the vertical forming tubes.

P, P′ are weight control devices.

S, S′ are packaged bags.

T, T′ are the dragging belts of the vertical forming tubes.

U indicates the possible operations of completing the fin.

V indicates the possible operations of trimming of said fin.

Z indicates the operations of folding of the fin and of attaching a label E onto the head of the bag.

The functioning of each single forming tube F, F′ of the plant showed schematically in the attached figures can be independently managed.

The forming tubes F, F′ can be fed with similar film of flexible material to package simultaneously identical bags containing the same amount of the same product.

In this instance, the productivity doubles compared to a known plant with a single row, while the operational speed of the single actuating devices of the packaging process is the same.

Furthermore, one of the two forming tubes can be in rest position for different operational needs, such as the film roll change, while the other forming tube is kept working under single production.

Of course the two forming tubes F, F′ can be employed to handle different films to package simultaneously bags by the external outlook differently customized.

It is obvious that the same plant can be set up with two forming tubes of different format to package bags that are different not only in the package but also in the quality and quantity of the packaged product.

It should be pointed out that the plant that forms the object of the present industrial invention, on top of being far cheaper than two separate plants, it also allows a considerable management economy not only in terms of total dimensions, but also in terms of people needed to operate it.

The present inventions highlights the overall versatility of the plant, that results optimized under all its industrial aspects.

Naturally the invention allows several variations of practical realization, both with respect to the dimensioning and the structural proportioning, as well as for the technological choices relative to the different single or grouped components.

All the packaging plants including at least two vertical forming tubes that result combined with a single central motorized conveyor equipped with dragging devices constituting several separate parallel tracks according to the number of vertical forming tubes, and having the features as described, showed and hereinafter claimed, will be considered as being part of the protection sphere of the present invention.

The inventive core on which the heuristic gradient of the present invention rests consists mainly in the combination of at least two vertical forming tubes with a single central motorized conveyor equipped with dragging devices constituting several parallel tracks according to the number of vertical forming tubes.

1. Packaging plant comprising:
at least two combined vertical forming tubes, and
a single motorized central conveyer equipped with dragging devices (D, D′) constituting at least two separate parallel tracks whose intermittent advancement is actuated by a main central motor(C),
wherein said at least two combined vertical forming tubes are placed in correspondence of the at least two separate parallel tracks provided with dragging devices and one of said at least two combined vertical forming tubes is placed ahead of the other one in a direction parallel to the direction of the at least two separate parallel tracks.

2. Packaging plant comprising at least two combined vertical forming tubes, as in claim 1, characterized by the fact that, at the same speed of single actuating devices of the packaging process, hourly production is doubled, tripled or increased four-folds according to the number of the at least two separate parallel tracks fed by the relative said at least two combined vertical forming tubes.

3. Packaging plant comprising at least two combined vertical forming tubes, as in claim 1, characterized by the fact that each single at least two combined vertical forming tubes are independent and different in kinds of packages that can be realized simultaneously, having different package types, format and quantity and quality of production.

4. A packaging plant comprising:
a single motorized conveyer;
a first dragging device mounted on said single motorized conveyer;
a second dragging device mounted on said single motorized conveyer adjacent said first dragging device, wherein said first and second dragging devices form first and second adjacent parallel tracks having a longitudinal direction of movement;
a first vertical forming tube positioned over said first dragging device; and
a second vertical forming tube positioned over said second dragging device and offset in the longitudinal direction from said first vertical forming tube,
whereby production is increased without increasing an operational speed of a single actuating device of the packaging process.
